(19) United States
(12) Patent Application Publication
(10) Pub. No.: US 2024/0083229 A1
(43) Pub. Date: Mar. 14, 2024

(54) Vehicle Scratch and Dent Prevention Device

(71) Applicant: Wilma Klein, Phoenix, AZ (US)

(72) Inventor: Wilma Klein, Phoenix, AZ (US)

(21) Appl. No.: 18/327,133

(22) Filed: Jun. 1, 2023

Related U.S. Application Data
(60) Provisional application No. 63/406,326, filed on Sep. 14, 2022.

(51) Int. Cl. B60J 11/06

(52) U.S. Cl. CPC B60J 11/06

(57) ABSTRACT

A vehicle scratch and dent prevention device is provided. The device is comprised of a protective panel that can be secured to the sides of a vehicle to absorb the impact from the opening doors of an adjacent vehicle. The protective panel can be easily applied to the sides of a vehicle for use when the vehicle is parked in a parking lot. When not in use, the panel is stored within a housing within and attached to a trunk of the vehicle.

### CROSS-REFERENCE TO RELATED APPLICATION

The present application claims priority to, and the benefit of, U.S. Provisional Application No. 63/406,326, which was filed on Sep. 14, 2022, and is incorporated herein by reference in its entirety.

### FIELD OF THE INVENTION

The present invention relates generally to the field of vehicle exterior protection devices. More specifically, the present invention relates to a vehicle scratch and dent prevention device comprised of a protective panel that can be secured to the sides of a vehicle to absorb the impact from the opening doors of an adjacent vehicle. The protective panel can be easily applied to the sides of a vehicle for use when the vehicle is parked in a parking lot. Accordingly, the present disclosure makes specific reference thereto. Nonetheless, it is to be appreciated that aspects of the present invention are also equally applicable to other like applications, devices, and methods of manufacture.

### BACKGROUND

Parking lots often try to accommodate as many vehicles as possible. However, with vehicles parked so closely together there is a risk of a vehicle being hit by a door opened from a vehicle parked next to it. This can cause dents and scratches on the surface of the first vehicle. These damages may be costly or take extended periods of time to fix. Further, the value of the vehicle may decrease if one decides not to address the damages, which hurts the resale value of the vehicle and may make it difficult to trade-in or sell.

Therefore, there exists a long-felt need in the art for a device that protects the sides of a vehicle when parked in a parking lot. More specifically, there exists a long-felt need in the art for a vehicle scratch and dent prevention device that can easily be affixed to the sides of a vehicle without damaging the vehicle itself. Furthermore, there exists a long-felt need in the art for a vehicle scratch and dent prevention device that can be attached and detached from the sides of a vehicle quickly and can be stored in a space-saving manner.

The subject matter disclosed and claimed herein, in one embodiment thereof, comprises a vehicle scratch and dent prevention device. The device is comprised of a housing, at least one protective panel, and at least one fastener. The protective panel can be removed from the housing during use, secured in the trunk of a vehicle when not in use, and then secured to the side of a vehicle via the fastener. The protective panel may be made of a foam material will provide protection to the side surface of a vehicle which the device is attached to from impacts from a second vehicle.

In this manner, the vehicle scratch and dent prevention device of the present invention accomplishes all the foregoing objectives and provides a device that protects the sides of a vehicle from scratches/dents when parked in a parking lot. More specifically, the vehicle scratch and dent prevention device can be affixed to the sides of a vehicle without damaging the surface of the vehicle. Furthermore, the vehicle scratch and dent prevention device can be stored in the vehicle and can be applied to and removed from the sides of the vehicle quickly and easily.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a vehicle scratch and dent prevention device comprised of a housing, at least one protective panel, and at least one fastener. The device is designed to attach to the sides of a vehicle and protect it from the doors of adjacent vehicles which may make impact when being opened. The device is comprised of a housing which is comprised of at least one opening and at least one strap. The housing may securely attach to the trunk of a vehicle via the strap. The opening allows for a protective panel to exit the housing during use. The protective panel, made of foam or a similar material, preferably exits the housing from an opening on either side of the housing.

The protective panel is comprised of at least one fastener, at least one connecting fastener, and at least one lip. The fastener is preferably a magnet embedded into the protective panel. In addition, the lip may be inserted into the door jamb of a vehicle to further secure the panel to the side of the vehicle during use. In this embodiment, the panel may be made of a plurality of segments, wherein a connecting fastener may attach each segment to the next segment of the panel.

The present invention is also comprised of a method of using the device. First, a device is provided comprised of a housing, a protective panel, and a fastener. Then, the housing is attached to the trunk of a vehicle via a strap. Next, the protective panel is pulled out of the housing and attached to the sides of the vehicle via a lip that may be pushed into a door jamb and a fastener. After being used, the protective panel is removed from the sides of the vehicle and folded and placed back into the housing.

Accordingly, the vehicle scratch and dent prevention device of the present invention is particularly advantageous as it provides a device that protects the sides of a vehicle when parked in a parking lot. More specifically, the vehicle scratch and dent prevention device can be stored in the trunk of a vehicle and applied to the sides of the vehicle for protection quickly and easily. Furthermore, the vehicle scratch and dent prevention device can be affixed to the sides of a vehicle without damaging the surface of the vehicle. In this manner, the vehicle scratch and dent prevention device provides a solution to prevent scratches and dents on the door of a vehicle.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a vehicle scratch and dent prevention device of the present invention while attached to a vehicle in accordance with the disclosed architecture;

FIG. 2 illustrates an enhanced perspective view of a lip and a protective panel of one potential embodiment of a vehicle scratch and dent prevention device of the present invention in accordance with the disclosed architecture;

FIG. 3 illustrates a perspective view of one potential embodiment of a vehicle scratch and dent prevention device of the present invention while attached to a vehicle in accordance with the disclosed architecture; and

FIG. 4 illustrates a flowchart of a method of using one potential embodiment of a vehicle scratch and dent prevention device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for a device that protects the sides of a vehicle when parked in a parking lot. More specifically, there exists a long-felt need in the art for a vehicle scratch and dent prevention device that can easily be affixed to the sides of a vehicle without damaging the vehicle itself. Furthermore, there exists a long-felt need in the art for a vehicle scratch and dent prevention device that can be attached and detached from the sides of a vehicle quickly and can be stored in a space-saving manner.

The present invention, in one exemplary embodiment, is comprised of a vehicle scratch and dent prevention device. The device is primarily comprised of a housing, at least one protective panel, and at least one fastener. The device is designed to be attached to the sides of a vehicle when parked in a parking lot to protect the vehicle from the doors of other vehicles opening and hitting the sides of this vehicle.

More specifically, the device is comprised of a housing which is further comprised of an at least one opening and at least one strap. The housing may be placed in the trunk of a vehicle and may securely attach to the trunk via the strap. The strap may be adjustable or made of an elastic material that allows the housing to universally attach to the trunk of any vehicle. The opening of the housing allows for a protective panel to exit the housing. In the preferred embodiment of the device, the housing is comprised of two openings, one on each side of the housing, to allow the protective panel to protect both sides of the vehicle.

The protective panel is comprised of an outside surface, at least one fastener, at least one connecting fastener, and at least one lip. The protective panel may be made of a foam or similar material that can absorb the force of a car door, which will protect the surface of the vehicle. In one potential embodiment, the outside surface of the protective panel may be comprised of any number of indicia that may allow the protective panel to match the appearance of the surface of the vehicle. The fastener of the protective panel is preferably a magnet but may be any fastener capable of attaching to the vehicle without damaging it. Further, the fastener is preferably embedded in the protective panel to not damage the surface of the vehicle.

The protective panel may be comprised of multiple segments of panels, each connected by the connecting fastener. The connecting fastener is preferably an elastic band, allowing the protective panel to stretch along the length of the side of the vehicle. In one potential embodiment, the multiple segments of panels may be able to fold in a segmented manner, allowing the protective panel to minimize space required for storage. The lip of the protective panel may aid in applying additional support for the protective panel by inserting into the door jamb of a vehicle. The lip may be made of a flexible plastic material and would lie perpendicular to the protective panel.

The present invention is also comprised of a method of using the device. First, a device is provided comprised of a housing, a protective panel, and a fastener. Then, the housing is attached to the trunk of a vehicle via a strap. Next, the protective panel is pulled out of the housing and attached to the sides of the vehicle via a lip that may be pushed into a door jamb and a fastener. Then, the protective panel is removed from the sides of the vehicle and folded and placed back into the housing.

Accordingly, the vehicle scratch and dent prevention device of the present invention is particularly advantageous as it provides a device that protects the sides of a vehicle when parked in a parking lot. More specifically, the vehicle scratch and dent prevention device can be secured to the side of a vehicle without causing damage to the vehicle itself. Furthermore, the vehicle scratch and dent prevention device can be attached to and detached from the sides of the vehicle for protection quickly, as well as be stored in the trunk of the vehicle from which it is protecting. In this manner, the vehicle scratch and dent prevention device provides a solution to preventing scratches and dents on the door of a vehicle.

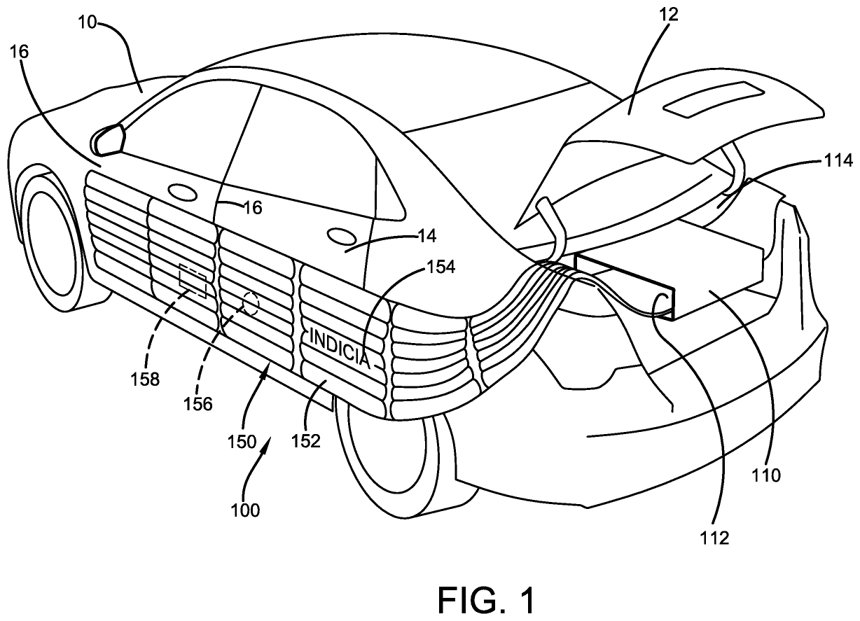

Referring initially to the drawings, FIG. 1 illustrates a perspective view of one potential embodiment of a vehicle scratch and dent prevention device 100 of the present invention while attached to a vehicle 10 in accordance with the disclosed architecture. The device 100 is primarily comprised of a housing 110, at least one protective panel 150, and at least one fastener 156. The device 100 is designed to be attached to the sides of a vehicle 10 when the vehicle 10 is parked in a parking lot. The device 100 protects the vehicle 10 from the doors of other vehicles parked next to the vehicle 10 that may impact the vehicle 10 when opening the doors of the second vehicle.

The housing 110 may be made of a plurality of materials such as rubber, stainless steel, or aluminum. The housing 110 is preferably rectangular in shape, but may resemble any other shape such as, but not limited to, a square, a triangle, a cylinder, a sphere, a circle, a prism, a pyramid, etc. The housing 110 may be secured to a trunk 12 of a vehicle 10 via at least one strap 114. The strap 114 is preferably made of an elastic material but may be a length-adjustable strap that allows the device 100 to universally attach to any vehicle 10. The housing 110 is also comprised of an at least one opening 112. In the preferred embodiment of the device 100, the housing 110 is comprised of two openings 112, one on each side of the housing 110, from which a protective panel 150 can enter and exit the housing 110.

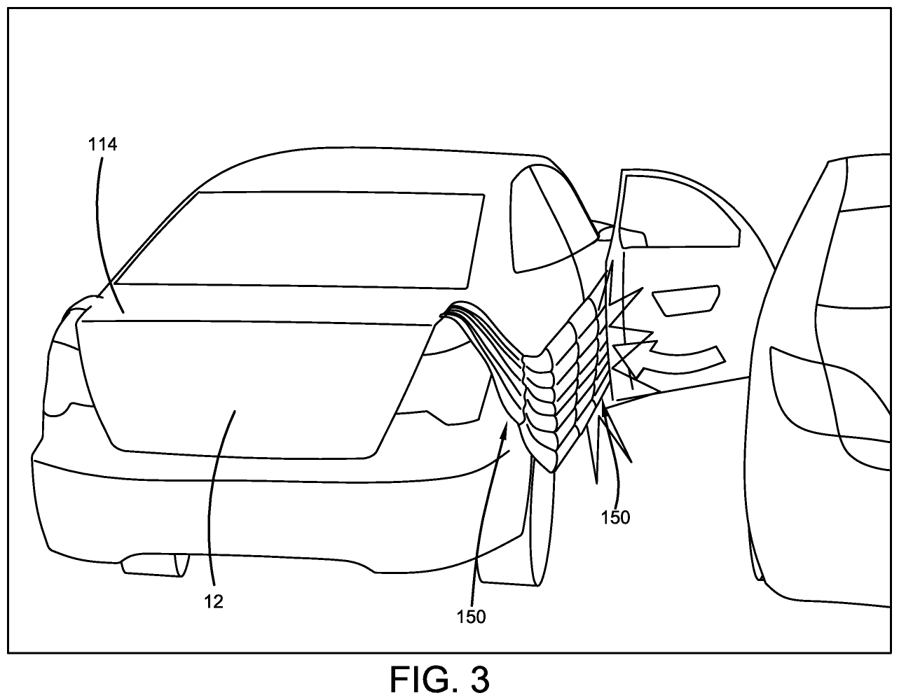

FIG. 3 illustrates a perspective view of one potential embodiment of a vehicle scratch and dent prevention device 100 of the present invention while attached to a vehicle 10 in accordance with the disclosed architecture. The protective panel 150 is comprised of an outside surface 152, at least one fastener 156, at least one connecting fastener 158, and at least one lip 160. The protective panel 150 may be made of a foam material, such as, but not limited to, polyethylene foam, cross-linked polyethylene foam, polyurethane foam, reticulated polyurethane foam, melamine foam, etc., or any other material that can absorb the impact from an opened door of a second vehicle into the side of the vehicle 10 the device 100 is attached to. In one potential embodiment, the outside surface 152 of the protective panel 150 may be comprised of a plurality of indicia 154 such as patterns, logos, emblems, images, symbols, designs, letters, words, characters, animals, advertisements, brands, etc., that may or may not match the protective panel 150 to the color or look of the vehicle 10.

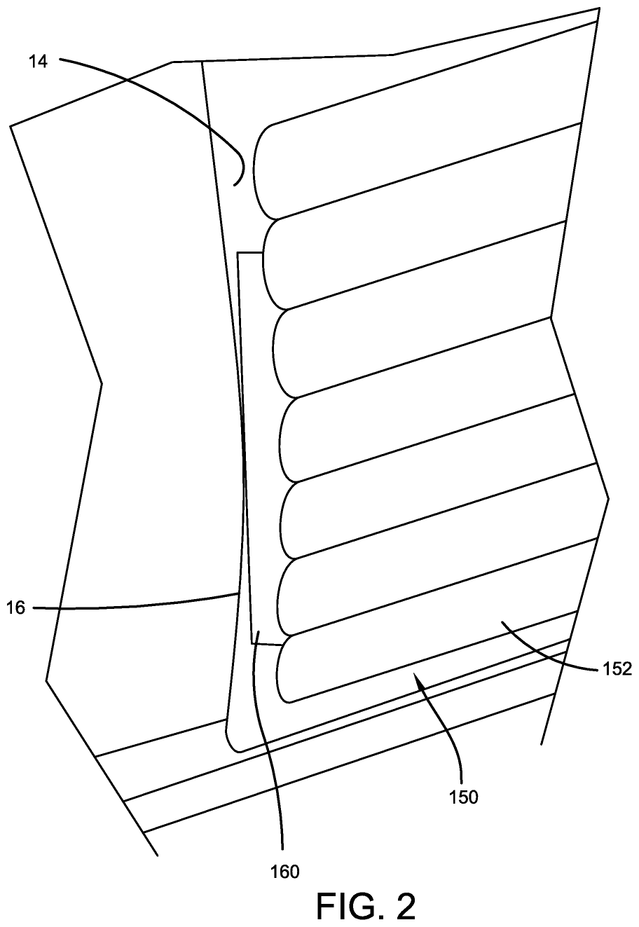

The protective panel 150 may attach to the side of the vehicle 10 via an at least one fastener 156. The fastener 156 may be any fastener 156 known in the art but is preferably a magnet that is embedded in the protective panel 150 so as to not damage the vehicle 10. In another embodiment, the fastener 156 is comprised of a suction cup positioned on the exterior surface of the panel 150. In addition, the lip 160 of the protective panel 150 may be made of a flexible plastic material that allows the lip 160 to insert into a door jamb 16 of a vehicle 10 to further secure the protective panel 150 to the vehicle 10, as best seen in FIG. 2. The protective panel 150, in one potential embodiment, may be made of a plurality of segments that may fold into each other for easy storage. In this embodiment, at least one connecting fastener 158 may secure each segment of the protective panel 150 to the next segment. The connecting fastener 158 may be an elastic band that runs through each segment, capable of stretching and collapsing to universally attach to the side of any vehicle 10.

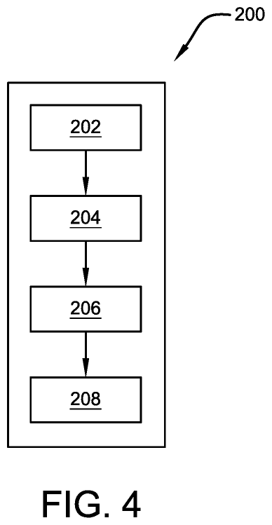

The present invention is also comprised of a method of using 200 the device 100, as seen in FIG. 4. First, a device 100 is provided comprised of at least one housing 110, at least one protective panel 150, and at least one fastener 156 [Step 202]. Then, the housing 110 is attached to a trunk 12 of a vehicle 10 via a strap 114 [Step 204]. Then, the protective panel 150 is pulled out of the housing 110 and attached to the sides of the vehicle 10 via a lip 160 that may be pushed into a door jamb 16 and/or a fastener 156 [Step 206]. Once done using the device 100, the protective panel 150 can be removed from the sides of the vehicle 10 and folded and placed back into the housing 110 [Step 208].

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “vehicle scratch and dent prevention device” and “device” are interchangeable and refer to the vehicle scratch and dent prevention device 100 of the present invention.

Notwithstanding the foregoing, the vehicle scratch and dent prevention device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the vehicle scratch and dent prevention device 100 as shown in the FIGS. are for illustrative purposes only, and that many other sizes and shapes of the vehicle scratch and dent prevention device 100 are well within the scope of the present disclosure. Although the dimensions of the vehicle scratch and dent prevention device 100 are important design parameters for user convenience, the vehicle scratch and dent prevention device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A vehicle scratch and dent prevention device comprising:
a protective panel;
a fastener;
a housing comprised of an opening; and
a strap attached to the housing.

2. The vehicle scratch and dent prevention device of claim 1, wherein the strap is comprised of an elastic strap.

3. The vehicle scratch and dent prevention device of claim 1, wherein the strap is comprised of a length-adjustable strap.

4. The vehicle scratch and dent prevention device of claim 1, wherein the protective panel is comprised of a foam material.

5. The vehicle scratch and dent prevention device of claim 1, wherein the protective panel is comprised of an indicia.

6. The vehicle scratch and dent prevention device of claim 1, wherein the fastener is comprised of a magnet.

7. The vehicle scratch and dent prevention device of claim 6, wherein the fastener is positioned within the protective panel.

8. The vehicle scratch and dent prevention device of claim 1, wherein the fastener is comprised of a suction cup.

9. The vehicle scratch and dent prevention device of claim 8, wherein the fastener is positioned on an exterior surface of the protective panel.

10. A vehicle scratch and dent prevention device comprising:
a protective panel;
a fastener;
a lip attached to the protective panel;
a housing comprised of an opening; and
a strap attached to the housing.

11. The vehicle scratch and dent prevention device of claim 10, wherein the strap is comprised of a length-adjustable strap.

12. The vehicle scratch and dent prevention device of claim 10, wherein the fastener is comprised of a magnet.

13. The vehicle scratch and dent prevention device of claim 12, wherein the fastener is positioned within the protective panel.

14. The vehicle scratch and dent prevention device of claim 10, wherein the lip is comprised of a flexible plastic material.

15. The vehicle scratch and dent prevention device of claim 10, wherein the strap is comprised of an elastic strap.

16. The vehicle scratch and dent prevention device of claim 10, wherein the fastener is comprised of a suction cup.

17. The vehicle scratch and dent prevention device of claim 16, wherein the fastener is positioned on an exterior surface of the protective panel.

18. A method of using a vehicle scratch and dent prevention device, the method comprising the following steps:
providing a vehicle scratch and dent prevention device comprised of a housing, a protective panel, and a fastener;
attaching the housing to a trunk of a vehicle via a strap of the vehicle scratch and dent prevention device;
pulling the protective panel from the housing and attaching the protective panel to a side of the vehicle via the fastener; and
removing the protective panel from the vehicle and placing the panel back within the housing.

19. The method of claim 18 further comprised of a step of attaching the protective panel to a side of the vehicle via a lip.

20. The method of claim 18, wherein the fastener is positioned within the protective panel.
